(19) United States
(12) Patent Application Publication
(10) Pub. No.: US 2004/0149538 A1
(43) Pub. Date: Aug. 5, 2004

(54) Compact multiple pocket processing system

(76) Inventor: Stanley P. Sakowski, Hanover Park, IL (US)

Correspondence Address: Paul R. Kitch, JENKENS & GILCHRIST, A PROFESSIONAL CORPORATION, 225 W. Washington, Ste. 2600, Chicago, IL, 60606-3418, US

(21) Appl. No.: 10/664,217

(22) Filed: Sep. 17, 2003

Related U.S. Application Data
(60) Provisional application No. 60/441,339, filed on Jan. 17, 2003.

(51) Int. Cl. G06K 7/00; G07D 7/00; G07F 7/04; G06K 9/00

(52) U.S. Cl. 194/207

(57) ABSTRACT

A compact currency handling system comprising a transportation mechanism including a facing mechanism. The device comprises an evaluation unit adapted to determine denomination of currency bills. The system is adapted to rest on a table top and output currency to seven output receptacles based on denomination. The bills in each output receptacle are commonly faced by the transport mechanism which is adapted to face bills flagged for facing. Faced bills an non-faced bills are merged to output the various output receptacles, wherein output is based on denomination of a bill.

### PRIORITY CLAIM AND CROSS REFERENCE

The present application claims priority from co-pending U.S. Provisional Application for Patent Serial No. 60/441,339, filed Sep. 17, 2002, the disclosure of which is hereby incorporated by reference.

### FIELD OF THE INVENTION

The present invention relates generally to the field of currency handling systems and, more particularly, to methods and devices for determining the fitness of currency bills or other conditions of the bills.

### BACKGROUND OF THE INVENTION

A variety of techniques and apparatuses have been used to satisfy the requirements of automated currency handling machines. As businesses and banks grow, these entities are experiencing a greater volume of paper currency. These entities are also requiring that their currency be processed more quickly and with more options in a less expensive manner. At the upper end of sophistication in this area of technology are machines that are capable of rapidly identifying, discriminating, and counting multiple currency denominations and then sorting the currency bills into a multitude of output compartments (or receptacles).

However, many of these high-end machines are extremely large and expensive such that they are commonly found only in large institutions. These machines are not readily available to entities that have monetary and space budgets, but still have the need to process large volumes of currency. Other high-end currency handling machines require their own climate controlled environment which may place even greater strains on an entity having monetary and space budgets. For example, one of these machines can cost over $500,000, it can weigh over 1,400 pounds, and measure over 5 feet in length, over 2 feet in depth, and over 5 feet in height. Additionally, the stringent environment specifications may require a narrow humidity range, such as between 50-55%, and a narrow temperature range, such as between 70-74° F.

There is a need for compact processing devices that satisfy a variety of separate processing tasks.

### SUMMARY OF THE INVENTION

The present invention is directed to compact multi-pocket currency sorting systems which include an input receptacle and a plurality (for example, five or more) output receptacles. A housing for the sorting system occupies a volume of not more than about 25,000 cubic inches. In one embodiment, the housing has a width of no more than about 54 inches, a depth of no more than about 17 inches and a height of no more than about 27 inches.

### BRIEF DESCRIPTION OF THE DRAWINGS

Other objects and advantages of the invention will become apparent upon reading the following detailed description in conjunction with the following drawings:

FIG. 1 is a block diagram illustrating a currency processing system in accordance with an embodiment of the present invention;

FIG. 2 is a front view of a currency processing device having multiple output receptacles;

FIG. 3 is a perspective view of the device of FIG. 2;

FIG. 4 is a block diagram for a multi-pocket sorting device;

FIGS. 5-13 show views of a compact multi-pocket sorter in accordance with the present invention;

FIGS. 14-20 illustrate views a scanhead for use in the compact multi-pocket sorter; and

FIGS. 21-22 are graphs illustrating operation of the scanhead.

### DETAILED DESCRIPTION OF THE DRAWINGS

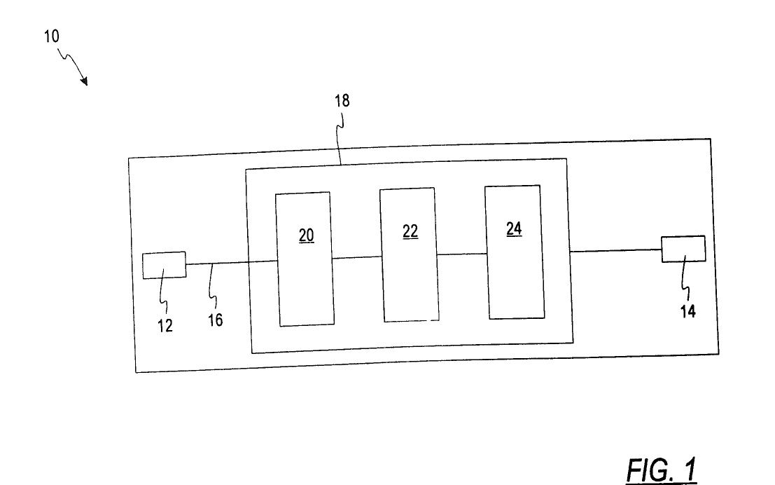

Reference is now made to FIG. 1 wherein there is shown a currency handling system 10 comprising an input 12 and an output 14. A transport device or mechanism 16 conveys currency bills from the input 12 (for example, an input receptacle) to the output 14 (for example, a plurality of output receptacles). An evaluation unit 18 is operatively positioned, although not necessarily physically positioned, between the input 12 and the output 14. The transport mechanism 16 is adapted to transport bills, received either individually or in bill bricks stacks, one at a time through the a fitness detector evaluation unit 18. The evaluation unit 18 may be adapted to evaluate any number of predetermined characteristics of the passing bills. Based on a determination made with respect to each bill, the bill is sorted in connection with its delivery to the output 14 by separating the bills into certain ones of the included output receptacles. This sortation may include taking a bill out of circulation, sending a bill to a counterfeit receptacle, sending a bill to a certain denomination receptacle, and the like.

In one example of evaluation, each bill is transported past a first detector 20 and then a second detector 22 followed by transport past a third detector 24. It will be understood that the evaluation detector 18 may comprise one or more of detectors for determining a predetermined criteria. Each detector may be used to address a different criteria, or alternatively plural detectors may be used with respect to the same criteria.

Embodiments of the present invention are directed to implementations of the currency handling system 10 in a compact manner.

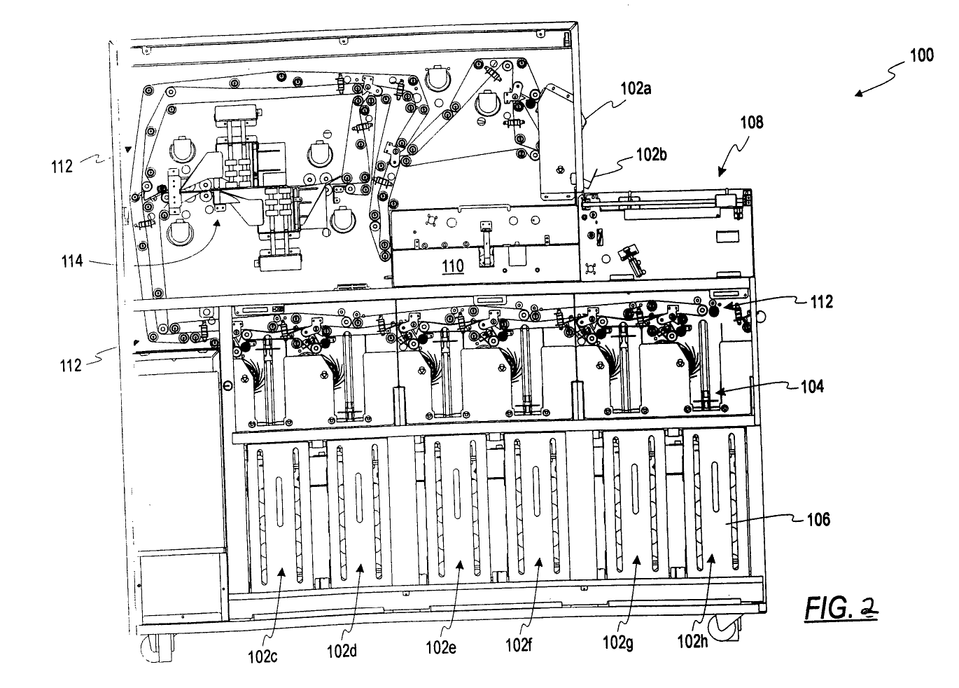

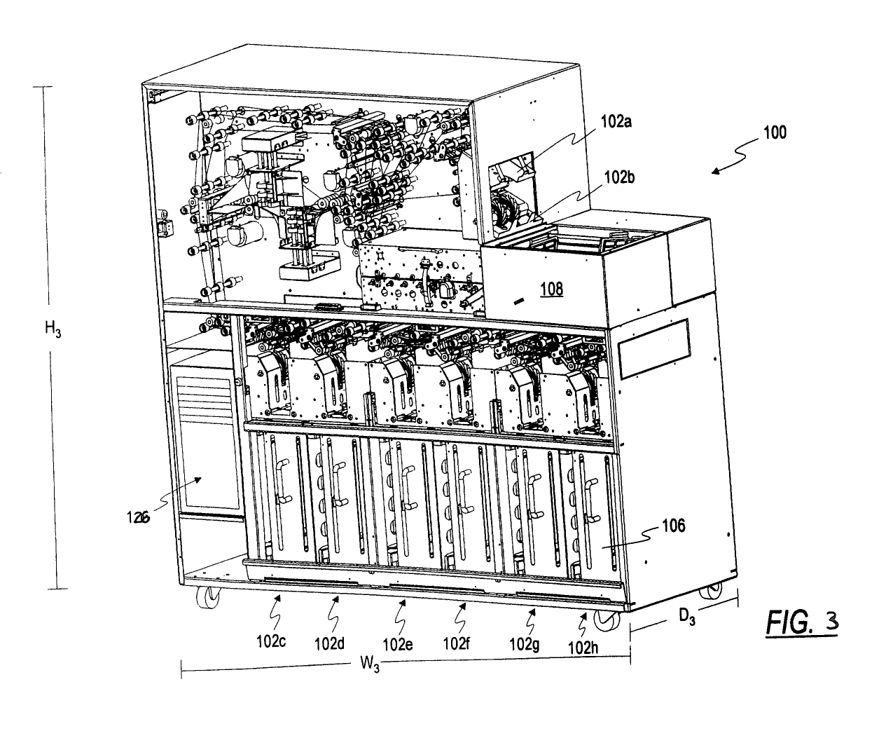

Reference is first, however, made to FIGS. 2 and 3 wherein there are shown views of a large format multi-pocket sorter (MPS) 100. The MPS 100 includes a plurality of output receptacles 102a-h. The MPS 100 is an embodiment of the system 10 of FIG. 1. The MPS 100 includes eight output receptacles 102a-h. These eight receptacles include two upper output receptacles 102a and 102b and six lower output receptacles 102c, 102d, 102e, 102f, 102g and 102h. The MPS 100 still further includes a functional capability to add modular lower output receptacles (not shown) to increase the total number of available lower output receptacles. Each of the lower output receptacles 102c-h includes an escrow region 104 (shown with respect to lower output receptacle 102h) for receiving and stacking currency bills and a storage cassette 106 for holding stacks of processed currency bills. Currency bills are transported to a particular one of the escrow regions 104 following processing/evaluation and sortation, and are then stacked therein. At specified times or on the occurrence of specific events, the currency bills that are stacked in a certain escrow region 104 are moved by the MPS 100 into the corresponding storage cassette 106. As an example, each storage cassette 106 is capable of holding up to approximately one thousand currency bills.

The MPS 100 is referred to as “large format” device. In this regard, the MPS 100 depicted in FIGS. 2 and 3 has conventional width W₃ of approximately 4.52 feet (1.38 meters), a height H₃ of approximately 4.75 feet (1.45 meters) and a depth D₃ of approximately 1.67 feet (0.50 meters). The MPS 100 further includes casters which allow the device to be moved. It will be recognized that such a large format device is a floor installation type model and possesses an overall volume of approximately 38.85 feet³ (3.34 meters³).

For more detail concerning such large format MPS 100 systems, the reader is directed to review commonly-assigned, co-pending application for patent U.S. Ser. No. 09/502,666 (Currency Handling System Having Multiple Output Receptacles), filed Feb. 11, 2000, which is incorporated herein by reference in its entirety.

The MPS 100 is capable of sorting bills according to denomination into each of the output receptacles. Using United States currency bills as an example, a stack of mixed currency bills is received in an input receptacle 108. In other embodiments of the present invention, the MPS 100 is capable of authenticating currency bills. Currency bills are transported, one at a time, from the input receptacle 108 through an evaluation region 110 by a transport mechanism 112 to the plurality of output receptacles 102a-h. In sorting the bills, the evaluation region 110 identifies the denomination of each of the currency bills and the transport mechanism delivers each bill to a particular one of the lower output receptacles 106c-h according to denomination (for example, U.S. $1 bills into lower output receptacle 106c, U.S. $5 bills into lower output receptacle 106d), while bills triggering error signals, such as no call or suspect document error signals, are off-sorted to upper output receptacles 102a and 102b. Numerous other operational alternatives are available to an operator of the MPS 100, including fit/unfit sorting. For example, the first upper output receptacle 102a can be used to receive bills triggering no call error signals and the second upper output receptacle 102b can be used to receive bills triggering suspect document error signals. Many other alternative operation modes and examples thereof are disclosed in commonly-owned, co-pending U.S. patent application Ser. Nos. 09/502,666 (filed Feb. 11, 2000) and 09/635,181 (filed Aug. 09, 2000), each of which is incorporated herein by reference in its entirety.

In some embodiments, the MPS 100 includes a bill facing mechanism 114, interposed in the transport mechanism 112, intermediate the bill evaluation region 110 and the lower output receptacles 102c-h that is capable of rotating a bill approximately 180° so that the face orientation of the bill is reversed. The leading edge of the bill (the wide dimension of the bill according to one embodiment) remains constant while the bill is rotated approximately 180° about an axis parallel to the narrow dimension of the bill) so that the face orientation of the bill is reversed. Further details of the operational and mechanical aspects a bill facing mechanism for use in the MPS 100 are disclosed in commonly owned U.S. Pat. No. 6,074,334 and U.S. Pat. No. 6,371,303, each of which is incorporated herein by reference in its entirety.

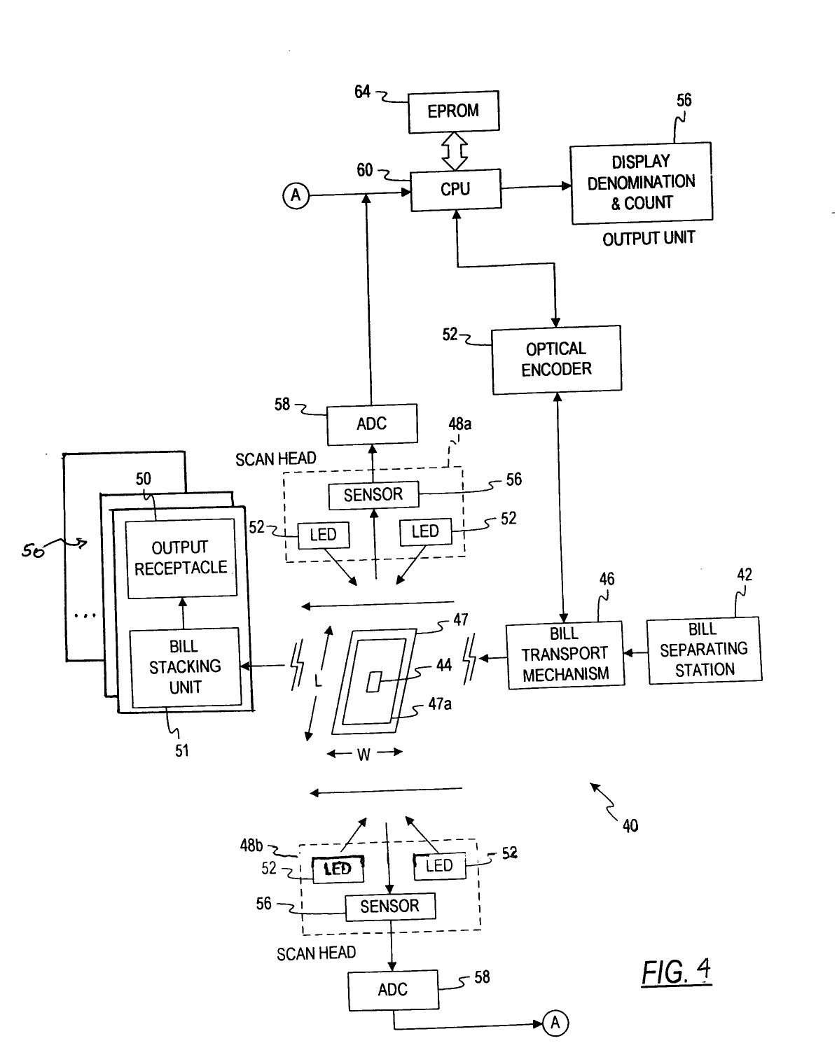

Reference is now made to FIG. 4, wherein there is shown a block diagram for a multi-pocket sorting device 40. The device 40 includes an input receptacle 42 (including a bill separation functionality) for receiving a stack of currency bills to be processed (for example, counted, denominated, authenticated, and the like). Currency bills in the input receptacle 42 are picked out or separated, one bill at a time, and sequentially relayed by a bill transport mechanism 46, between a pair of scanheads 48a and 48b where, for example, the currency denomination of each bill is scanned and identified. In the illustrated embodiment, each scanhead 48 is an optical scanhead that scans for optical characteristic information from a scanned bill 47 which is used to identify the denomination of the bill. The scanned bill 47 is then transported through a sortation functionality to a selected one of a plurality of output receptacles 50. Each of the receptacles includes a stacking unit 51 which operates to assist in stacking the bills within the receptacles 50 for subsequent removal. The device 40 includes an operator interface 53 with a display 56 for communicating information to an operator of the device 40, and buttons 57 for receiving operator input.

Additional sensors may replace or are used in conjunction with the optical scanheads 48a and 48b in the device 40 to analyze, authenticate, denominate, count, and/or otherwise process currency bills. These sensors comprise the detectors 20-24 described above in connection with FIG. 1. For example, size detection sensors, magnetic sensors, thread sensors, and/or ultraviolet/fluorescent light sensors may be used in the currency processing device 40 to evaluate currency bills. Uses of these types of sensors for currency evaluation are described in commonly owned U.S. Pat. No. 6,278,795, which is incorporated herein by reference in its entirety. Likewise, one or more embodiments of fitness detectors may be used in connection with the optical scanners.

In some applications of the currency processing device 40, each optical scanhead 48a and 48b comprises a pair of light sources 52, such as light emitting diodes, that direct light onto the bill transport path so as to illuminate a substantially rectangular light strip 44 upon a currency bill 47 positioned on the transport path adjacent the scanhead 48. Light reflected off the illuminated strip 44 is sensed by a photodetector 56 positioned between the two light sources. The analog output of the photodetector 56 is converted into a digital signal by means of an analog-to-digital convertor (“ADC”) 58 whose output is fed as a digital input to a processor such as central processing unit (CPU) 60.

The bill transport path is defined in such a way that the transport mechanism 46 moves currency bills with the narrow dimension of the bills parallel to the transport path and the scan direction. As a bill 47 traverses the scanheads 48 the light strip 44 effectively scans the bill across the narrow dimension of the bill 47. In the depicted embodiment, the transport path is arranged so that a currency bill 47 is scanned across a central section of the bill along its narrow dimension, as shown in FIG. 4. Each scanhead functions to detect light reflected from the bill 47 as it moves across the illuminated light strip 44 and to provide an analog representation of the variation in reflected light, which, in turn, represents the variation in the dark and light content of the printed pattern or indicia on the surface of the bill 47. This variation in light reflected from the narrow dimension scanning of the bills serves as a measure for distinguishing, with a high degree of confidence, among a plurality of currency denominations that the system is programmed to process.

Additional details of the device 40 illustrated in FIG. 4 and processes for using the same are described in U.S. Pat. Nos. 5,295,196 and 5,815,592, each of which is incorporated herein by reference in its entirety. According to various alternative embodiments, the currency processing device 40 is capable of processing, including fitness evaluating and denominating the bills, singularly or in combination, from about 800 to over 1500 bills per minute. Furthermore, a multi-functional processor may be programmed to only evaluate fitness, for example, of bills at speeds from about 800 to over 1500 bills per minute.

While the device 40 of FIG. 4 has been described as a device capable of determining the denomination of processed bills, it may alternatively or additionally function as a note counting device. Note counting devices are disclosed in commonly owned U.S. Pat. Nos. 6,026,175 and 6,012,565 and in commonly owned, co-pending U.S. patent application Ser. No. 09/611,279, filed Jul. 6, 2000, each of which is incorporated herein by reference in its entirety. Note counting devices differ from currency denominating devices in that note counting devices do not denominate the currency bills being processed and are not designed to process and determine the total value of a stack of mixed denomination currency bill. But fitness detection may also be used in note counting devices.

As indicated above, embodiments of the invention are particularly directed toward MPS devices 40 and systems 10 having compact designs. Even more particularly, but without limitation, embodiments of the invention are directed to the implementation of MPS devices and systems as a table-top version.

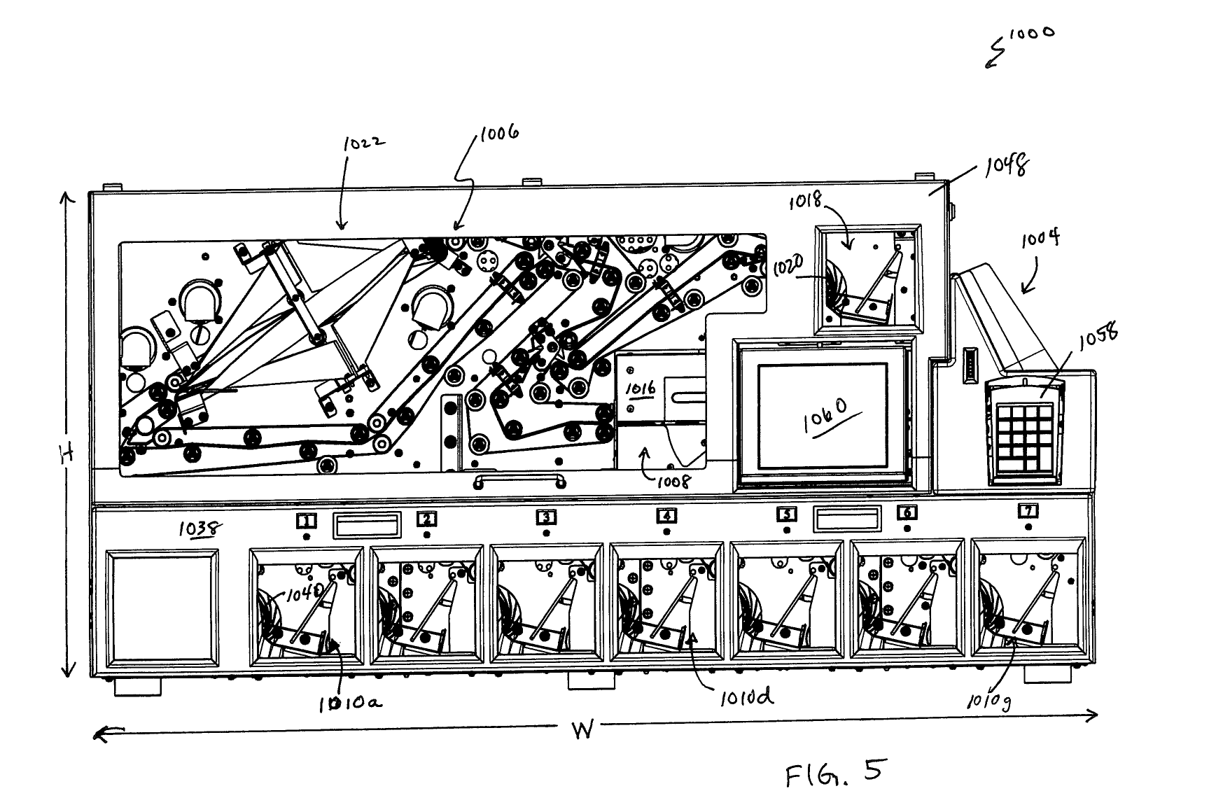

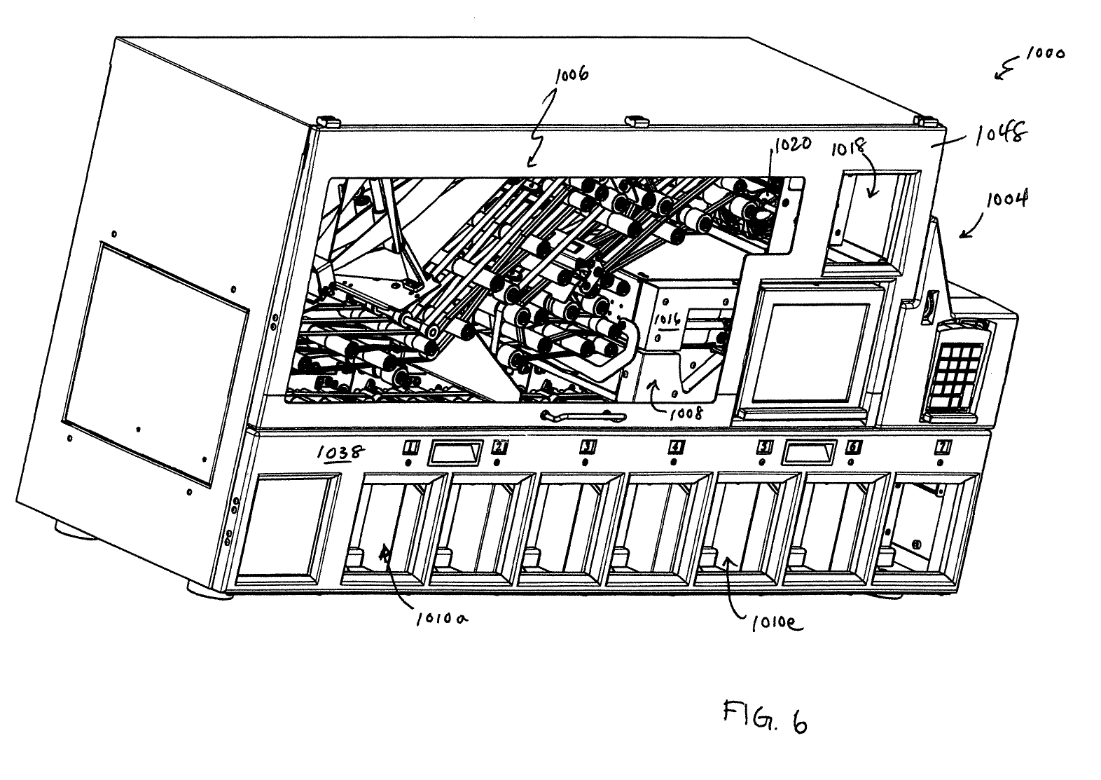

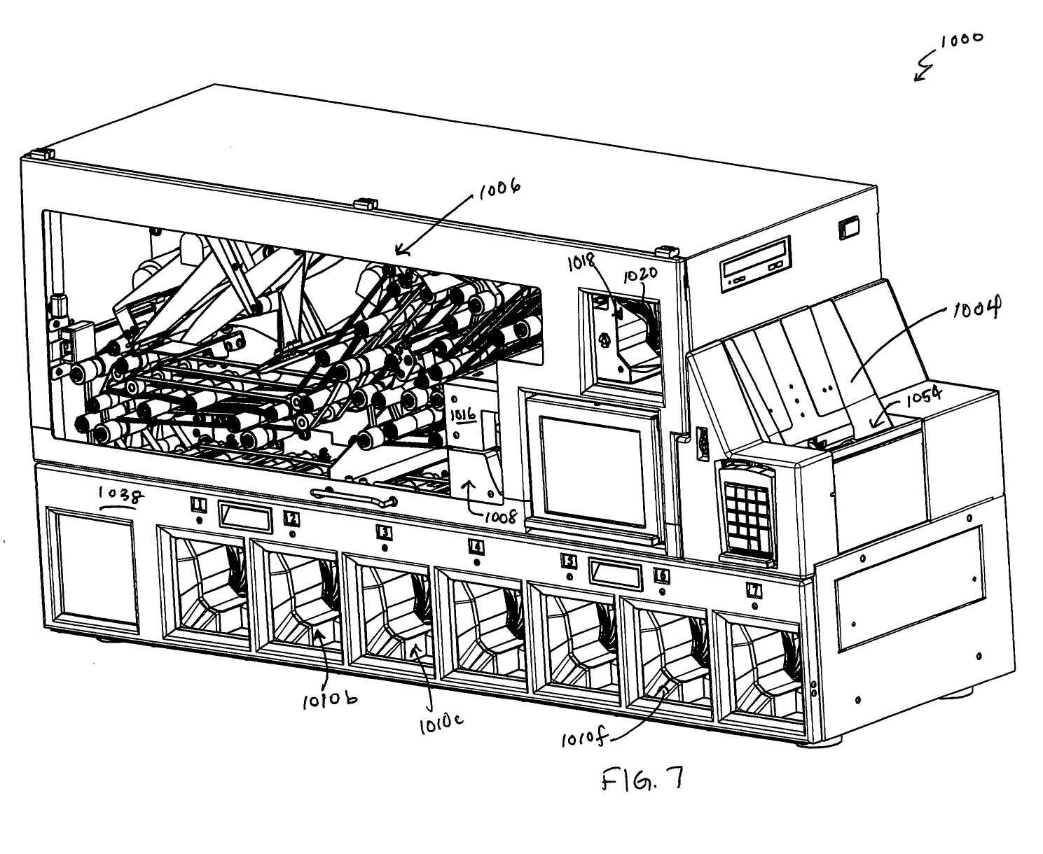

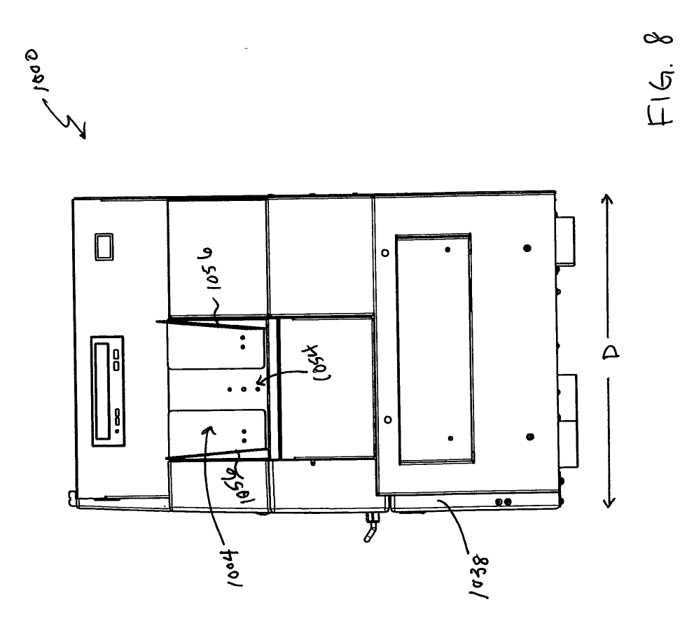

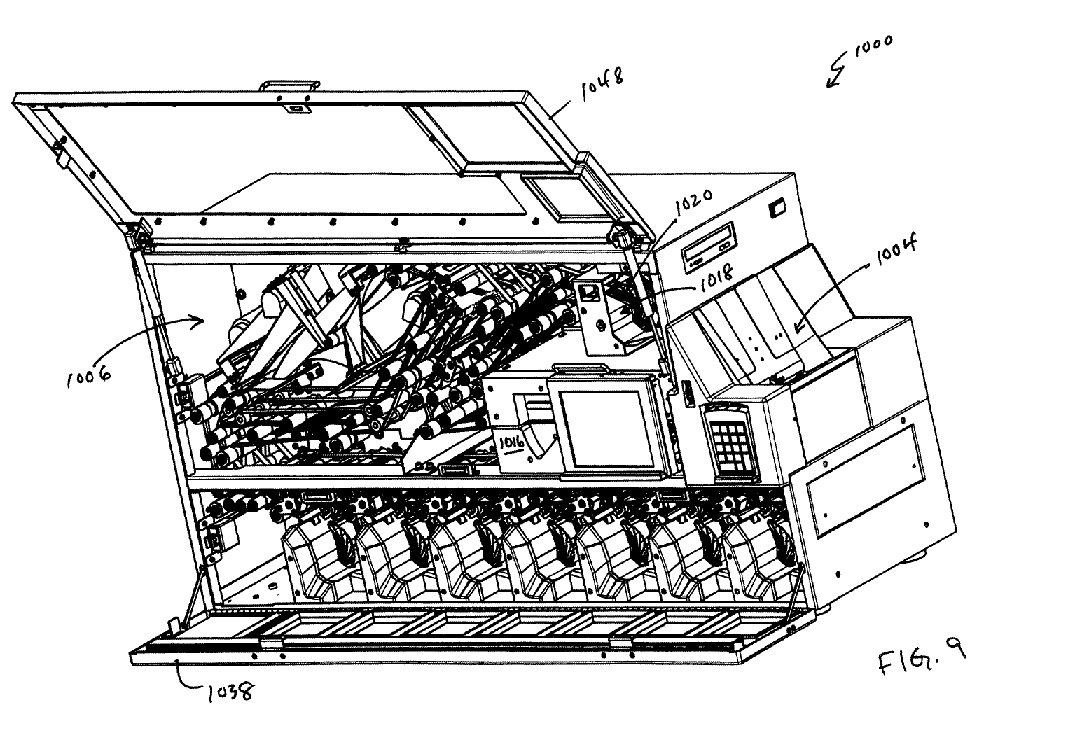

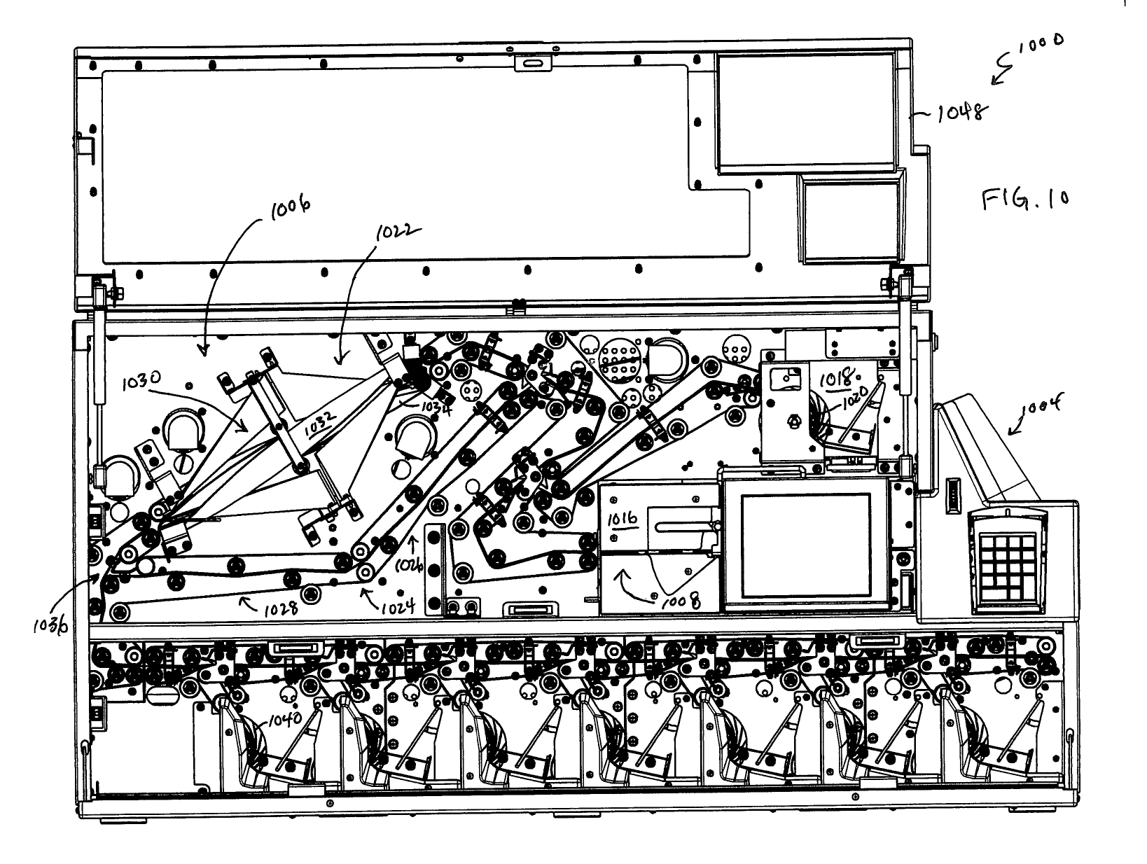

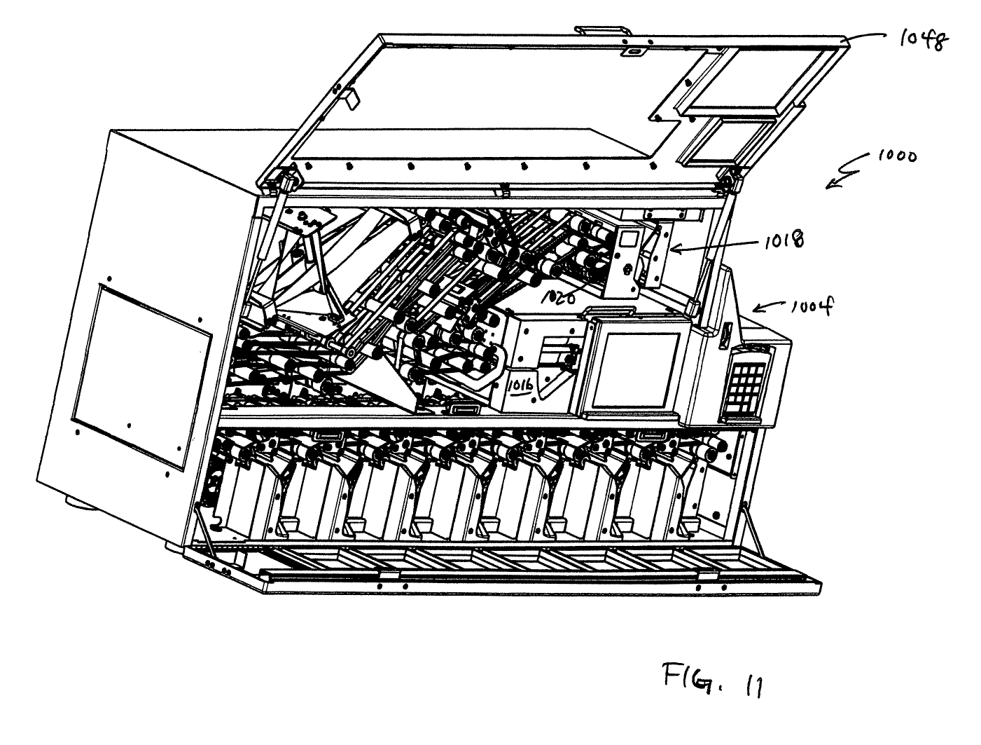

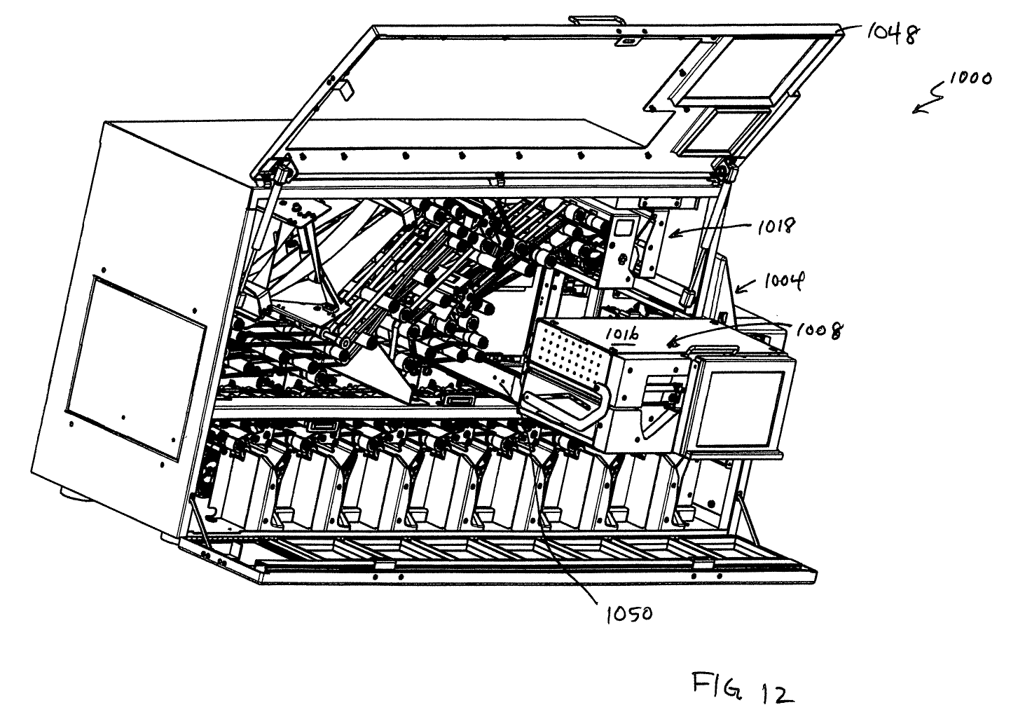

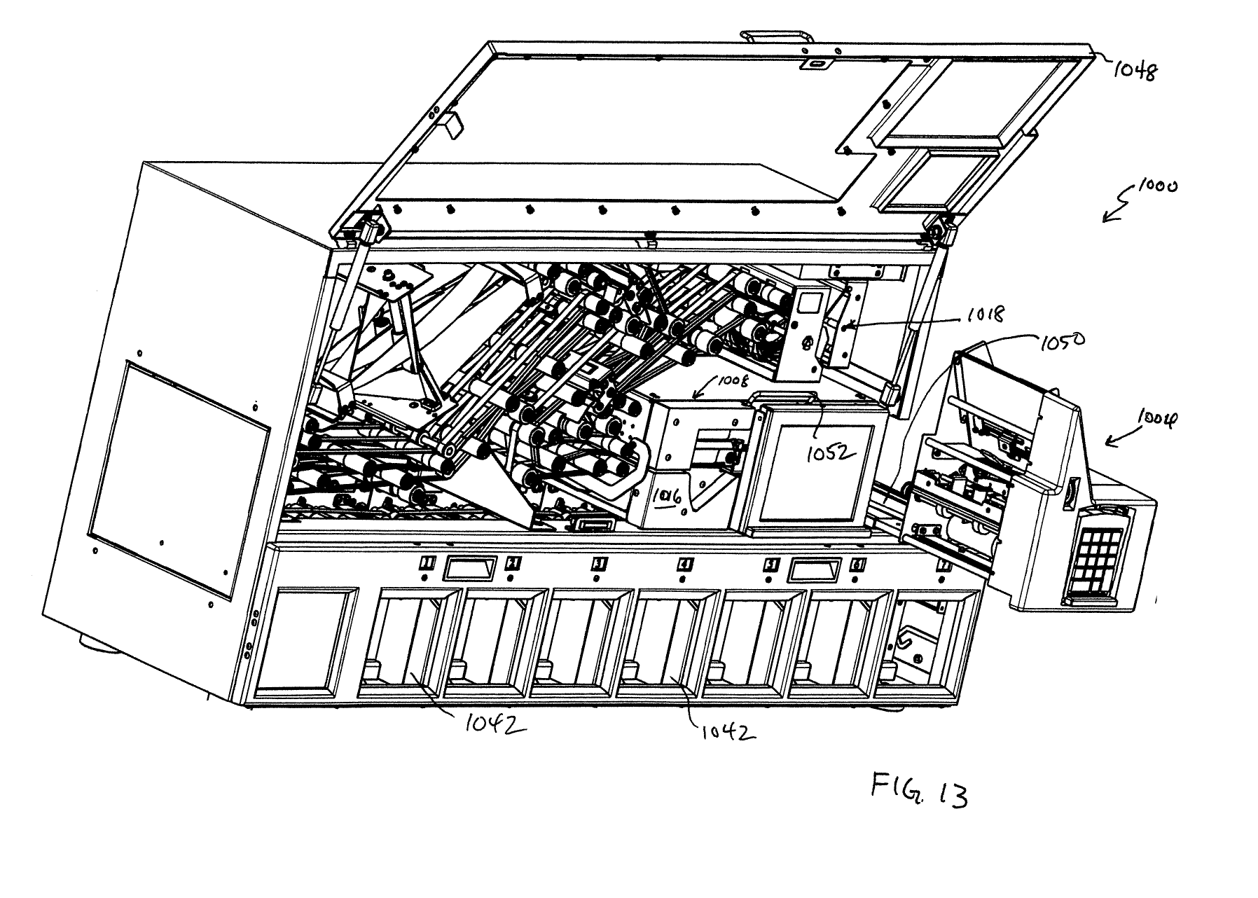

Reference is now made to FIGS. 5-13 wherein there are shown view of a compact MPS 1000 in accordance with the present invention. Generally speaking, the compact (or table-top) format MPS 1000 operates in a manner similar to that of the large format MPS 100 shown in FIGS. 2 and 3. However, the compact format MPS 1000 is configured differently in order to achieve a smaller physical footprint and volume than the large format MPS 100. In the compact format MPS 1000, for example, the lower output receptacles 1010 do not include or utilize storage cassettes 106. Instead, the escrow regions 104 make up the lower output receptacles 1010. This has a significant effect on the volume/space requirements of the device. More specifically, at least the overall height of the machine is significantly reduced. Weight is also significantly reduced by the subtraction of combined escrow and cassette functionality. Additionally, because of the space reduction, the device can be configured as a table-top unit (as opposed to a floor unit).

The teachings disclosed herein have particular suitability to applications that benefit from use of a compact MPS device 1000. Although an embodiment of a compact MPS device 1000 is described herein, one of ordinary skill in the art will understand that the teachings presented are not limited to the illustrated embodiment. Additionally, one of ordinary skill in the art will appreciate that the compact MPS device 1000 can be adapted to operate in a plurality of different operating modes, including, but not limited to, a dynamic sort mode. U.S. patent application Ser. No. 10/068,977 filed Feb. 8, 2002, entitled “Multiple Pocket Currency Processing Device and Method,” which is commonly assigned and incorporated herein by reference in its entirety, provides further details concerning modes of operation compatible with the compact MPS device 1000. Generally, the device 1000 may be selectively programmed to operate in any of several operating modes which may be generally categorized as “stranger modes,” “sort modes,” “mixed modes” and “count modes.” Typically each category comprises two or more specific modes of operation. An operator may select any one individual operation mode or a combination of operation modes selected from different categories. Stranger modes are used to process a stack of notes expected to be of the same denomination, where the operator desires to remove stranger notes note detected as being of the same denomination. Sort modes are typically designed to accommodate a pre-sorted stack of notes having a rainbow configuration. An example of a rainbow configuration is where the stack of notes includes two or more groups of notes, each group having a different denomination but each note within a given group having the same denomination. Mixed modes are generally selected to accommodate a stack of notes having a mixed configuration. An example of a mixed configuration is one including two or more denominations of notes in no particular order, where the operator desires to determine the number or aggregate value of notes of each respective denomination. A count mode is typically designed to accommodate a stack of notes in any configuration, where the operator desires to determine the number or total value of notes in a stack.

With reference now to FIGS. 5-13, a compact MPS device 1000 is presented which is adapted to rest on a table top. The compact MPS 1002 has a significantly reduced dimensional requirement comprising, for example, a width (W) of 54 inches, height (H) of 27 inches and a depth (D) of 17 inches. Thus, the illustrated embodiment for the compact MPS 1000 has a footprint of approximately 1000 inches². A stack of currency bills is placed in an input receptacle 1004. A transport mechanism 1006 transports the currency bills, individually, from the input receptacle 1004 through an evaluation section 1008 to one or more output receptacles 1010a-1010g. The transport mechanism 1006 comprises an input section 1012, including a stripping mechanism, to remove bills, one at a time, from the stack of bills in the input receptacle 1004. The evaluation section 1008 comprises an evaluation unit 1016 adapted to subject each bill to one or more evaluation processes. One of such evaluation comprises detecting whether a bill needs to be faced (rotated 180 degrees so as to allow all bills of a given denomination to be faced in a common direction). The evaluation unit 1016 is also adapted to determine the denomination of a bill. Subsequent sortation of the bill to the receptacles 1010 may be made based on the determined denomination. The evaluation unit 1016 may further be adapted to discern other characteristics of the bill (for example, counterfeit, no-call, dirty, fitness, ripped or torn, and the like). Subsequent sortation of the bill to the receptacles 1010 may be made based on the determined characteristics of the bill.

The transport mechanism 1006 transports bills exiting the evaluation unit upward at approximately a 45 degree angle towards an off-sort receptacle 1018. A diverter functions to divert bills from the transport path towards the off-sort receptacle. Non-diverted bills (“good bills”) continue along the transport path for further processing. The receptacle 1018 includes stacking wheels 1020 to stack off-sorted bills in the off-sort receptacle 1018.

If the evaluation unit 1016 detects and indicates that good bills need to be faced, they are transported toward a facing-router 1022, where bills detected as needing to be faced are routed by a diverter upward to the left. Good bills that do not need to be faced are instead routed by the diverter downward to the left toward a through-way section 1024 which by passes the facing router 1022 and leads more directly to the one or more output receptacles 1010a-1010g. The through-way section 1024 comprises a first connector section 1026 angled downward at about 45 degrees and a second connector section 1028 connected to the first connector section 1026. Bills to be faced are transported from the facing router 1022 to a facing section 1030, which comprises a facing mechanism. One or more twisted belts 1032 and 1034 cooperate to rotate the bill 180 degrees as the bill is transported to a merger section 1036. The rate of transfer through the facing section and throughway section is controlled such that the separated bills can thereafter be effectively merged back together into a single transport path. For example, this can be accomplished by operating the sections at the same rate where each section has substantially identical length. Alternatively, different lengths can be used for each section, but each section has a different processing rate. Good bills transported through the facing section 1030 are merged with good bills transported through the through-way section 1024 in a merging device to form a stream of bills being output to the output receptacles 1010a-1010g. In this manner, all bills corresponding to a sensed denomination may be transported to a single output receptacle and be commonly faced. A significant advantage achieved with the MPS 1000 is that bills do not need to be post-processed, by hand for example, to face them. Thus, the MPS device 1000, which is sized to fit on a standard table top, and comprises both an evaluation unit 1016, e.g., an image scanner, and a facing section 1030; enabling it to output commonly faced denominated bills to one or more output receptacles 1010a-g.

The output receptacles are positioned behind an output access panel 1038 to avoid injury to users from, for example, one of the plurality of stacker wheels 1040, which operate at high speeds. In order to provide convenient access to denominated bills, the output access panel may be provided with openings 1042 providing access to the output receptacles 1010a-1010g.

The MPS device 1000 is adapted to process bills at variable rates, including rates up to 1000 bills-per-minute. Frequently the bills being processed include damaged bills. Occasionally, when operating at such high speeds, processing a damaged bill may result in mis-feeds and jams. To easily remedy these problems, the transport mechanism 1006 is accessible by opening a transport mechanism access panel 1048 to allow jams to be cleared. For similar reasons, the evaluation unit 1016 slides forward on guides 1050. A handle 1052 facilitates movement of the evaluation unit 1016, which may itself be opened to access its interior. Likewise, the input receptacle 1004 slides forward on guides 1050 to clear jams and the like.

The input receptacle 1004 comprises a feed-hopper 1054 which is slightly canted and oriented to provide gravity feed. Two movable vanes 1056a-b are adjusted to butt against the short edge of bills stacked in the feed-hopper 1054. A keypad 1058 is pivotally mounted proximate to the feed-hopper 1054 to maintain compact dimensions while facilitating use of the device 1000. An LCD touch screen 1060 provides a second user interface, the keypad 1058 being the first user interface. As with the keypad 1058, the touch screen 1060 is pivotally mounted proximate to the feed-hopper 1054. The screen 1060 may be tilted outward from a pivot positioned proximate its upper edge.

In some embodiments of the compact MPS device 1000, the device comprises a width (W) of not more than about 54 inches, a height (H) of not more than about 27 inches and a depth (D) of not more than about 17 inches. The compact MPS device 1000 can also be adapted to fit within dimensions of a width of not more than about 4.5 feet, height of not more than about 2.25 feet, and depth of not more than about 1.5 feet. In some applications, the device is adapted to comprise a width of not more than about 140 cm, a height of not more than about 70 cm, and a depth of not more than about 45 cm. It will be apparent to one of ordinary skill in the art that the terms width, height, and depth are used to facilitate clear description of the illustrated embodiment rather than particular required relationships. Accordingly, in some embodiments, the device comprises a volume of not more than about 25,000-33,000 inches³. For some embodiments the device comprises a volume of not more than about 17 feet³. It will also be understood that although the device is referred to as a table-top device, the device is not required to rest on a table. And although the illustrated embodiment comprises a footprint of approximately 1000 inches² and a volume of about 25,000 inches³, it will be appreciated that other footprints and volumes, both larger and smaller than those of the illustrated embodiment, will be suitable for different applications. Further, the device need not have the long edge parallel to the ground. It is also to be understood that the aforementioned dimensions are with reference to major structure, e.g., a housing containing the transport mechanism 1006 and the plurality of output receptacles 1010. The aforementioned measurements generally do not include protrusions, extensions, attachments and such.

An embodiment of a scanhead 400 that is suitable for use in the compact MPS device 1000 is described with reference to FIGS. 14-19. The scanhead 400 includes a body 402 that has a plurality of filter and sensor receptacles 403 along its length. Each receptacle 403 is designed to receive a color filter 406 (which may be a clear piece of glass) and a sensor 404, one set of which is shown in an exploded view in FIG. 14. A filter 406 is positioned proximate a sensor 404 to transmit light of a given wavelength range of wavelengths to the sensor 404. As illustrated in FIG. 15, one embodiment of the scanhead housing 402 can accommodate forty-three sensors 404 and forty-three filters 406.

A set of three filters 406 and three sensors 404 comprise a single color cell 434 on the scanhead 400. According to one embodiment, three adjacent receptacles 403 having three different primary color filters therein constitute one full color cell, for example, cell 434a. The scanhead 400 further includes a reference sensor 450.

The sensors 404 and filters 406 are positioned within the filter and sensor receptacles 403 in the body 402 of the scanhead 400. Each of the receptacles has ledges 432 for holding the filters 406 in the desired positions. The sensors 404 are positioned immediately behind their corresponding filters 406 within the receptacle 403.

FIG. 18 illustrates one full color cell such as cell 434a on the scanhead 400. The color cell 434a comprises a receptacle 403r for receiving a red filter 406r (not shown) adapted to pass only red light to a corresponding red sensor 404r (not shown).

The cell further comprises a blue receptacle 403b for receiving a blue filter 406b (not shown) adapted to pass only blue light to a corresponding blue sensor 404b, and a green receptacle 403g for receiving a green filter 406g (not shown) adapted to pass only green light to a corresponding green sensor 404g. Additionally, there are sensor partitions 440 between adjacent filter and sensor receptacles 403 to prevent a sensor in one receptacle, for example, receptacle 403b, from receiving light from filters in adjacent receptacles, for example, 403r or 403g. In this way, the sensor partitions eliminate cross-talk between a sensor and filters associated with adjacent receptacles. Because the sensor partitions 440 prevent sensors 404 from receiving wavelengths other than their designated color wavelength, the sensors 404 generate analog outputs representative of their designated colors. Other full color cells such as cells 434b, 434c, 434d and 434e are constructed identically.

The cells are divided from each other by cell partitions 436 which extend between adjacent color cells 434 from the sensor end 424 to the mask end 422. These partitions ensure that each of the sensors 404 in a color cell 434 receives light from a common portion of the bill. The cell partitions 436 shield the sensors 404 of a color cell 434 from noisy light reflected from areas outside of that cell's scan area such as light from the scan area of an adjacent cell or light from areas outside the scan area of any cell. To further facilitate the viewing of a common portion of a bill by all the sensors in a color cell 434, the sensors 404 are positioned 0.655 inches from the slit 418. This distance is selected based on the countervening considerations that (a) increasing the distance reduces the intensity of light reaching the sensors and (b) decreasing the distance decreases the extent to which the sensors in a cell see the same area of a bill. Placing the light source on the document side of the slit 418 makes the sensors more forgiving to wrinkled bills because light can flood the document since the light is not restricted by the mask 410. Because the light does not have to pass through the slits of a mask, the light intensity is not reduced significantly when there is a slight (for example, 0.03″) wrinkle in a document as it passes under the scanhead 400.

The dimensions (l, w, h) of the filters 406 are 0.13, 0.04, 0.23 inches and the dimensions of the filter receptacles 403 are 0.141×0.250 inches and of the sensors 304 are 0.174×0.079×0.151 inches. The active area of each sensor 404 is 0.105×0.105 inches.

Each sensor generates an analog output signal representative of the characteristic information detected from the bill. Specifically, the analog output signals from each color cell 434 are red, blue and green analog output signals from the red, blue and green sensors 404r, 404b and 404g, respectively. These red, blue and green analog output signals are amplified by an amplifier and converted into digital red, blue and green signals by means of an analog-to-digital converter (ADC) unit whose output is fed as a digital input to a central processing unit (CPU). According to one embodiment, the outputs of an edge sensor 438 and the green sensor of the left color cell 434a are monitored by a processor to initially detect the presence of the bill adjacent the color scanhead 400 and, subsequently, to detect the bill edge.

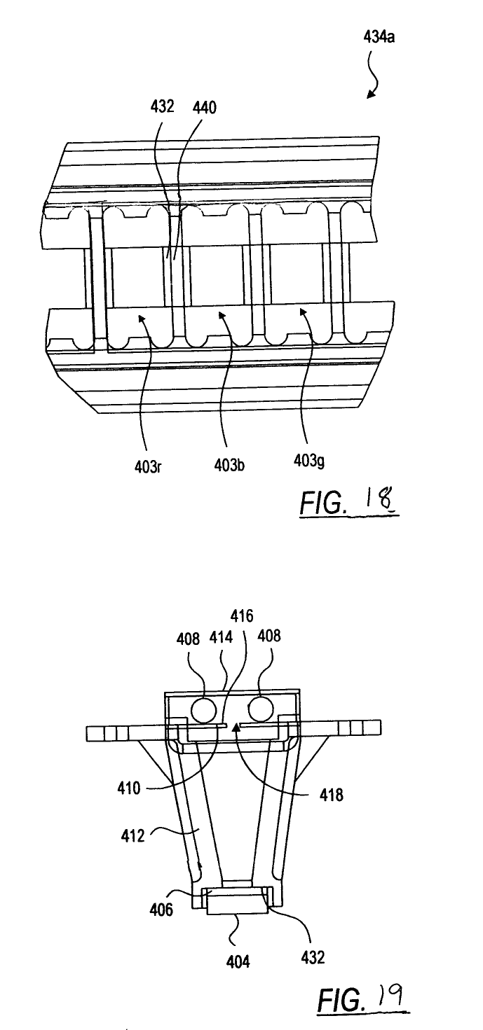

As seen in FIG. 19, a mask 410 having a narrow slit 418 therein covers the top of the scanhead. The slit 418 is 0.050 inches wide. A pair of light sources 408 illuminate a bill as it passes the scanhead 400 on the transport plate. The illustrated light sources 408 are fluorescent tubes providing white light with a high intensity in the red, blue and green wavelengths. The fluorescent tubes 408 may be part number CBY26-220NO manufactured by Stanley of Japan. These tubes have a spectrum from about 400 mm to 725 mm with peaks for blue, green and red at about 430 mm, 540 mm and 612 mm, respectively. The light from the light sources 408 passes through a transparent glass shield 414 positioned between the light sources 408 and the transport plate. The glass shield 414 assists in guiding passing bills flat against the transport plate as the bills pass the scanhead 400. The glass shield 414 also protects the scanhead 400 from dust and contact with the bill.

The illustrated embodiment is adapted to compensate for light diffusion. Because light diffuses with distance, the scanhead 400 is designed to position the light sources 408 close to the transport path to achieve a high intensity of light illumination on the bill. In one embodiment, the tops of the fluorescent tubes 408 are located 0.06 inches from the transport path. The mask 410 of the scanhead 400 also assists in illuminating the bill with the high intensity light. The mask 410 has a reflective surface 416 facing to the light sources 408. The reflective side 416 of the mask 410 directs light from the light sources 408 upwardly to illuminate the bill.

Light reflected off the illuminated bill enters a manifold 412 of the scanhead 400 by passing through the narrow slit 418 in the mask 410. The slit 418 passes light reflected from the scan area or the portion of the bill directly above the slit 418 into the manifold 412. The reflective side 416 of the mask 410 blocks the majority of light from areas outside the scan area from entering the manifold 412. In this manner, the mask serves as a noise shield by preventing the majority of noisy light or light from outside the scan area from entering the manifold 412. In one embodiment, the slit has a width of 0.050 inch and extends along the 6.466 inch length the scanhead 400. The distance between the slit and the bill is 0.195 inch, the distance between the slit and the sensor is 0.655 inch, and the distance between the sensor and the bill is 0.85 inch. The ratio between the sensor-to-slit distance and the slit-to-bill distance is 3.359:1. By positioning the slit 418 away from the bill, the slit 418 passes light reflected from a greater area of the bill. Increasing the scan area yields outputs corresponding to an average of a larger scan area. One advantage of employing fewer samples of larger areas is that the currency handling system is able to process bills at a faster rate, such as at a rate of 1200 bills per minute. Another advantage of employing larger sample areas is that by averaging information from larger areas, the impact of small deviations in bills which may arise from, for example, normal wear and/or small extraneous markings on bills, is reduced.

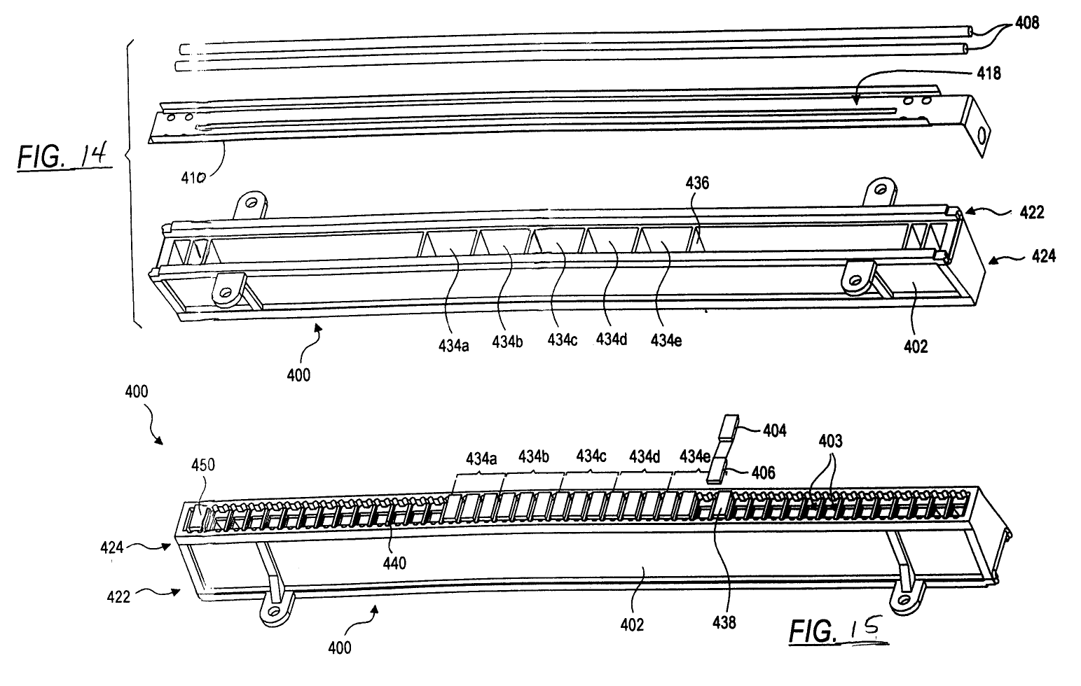

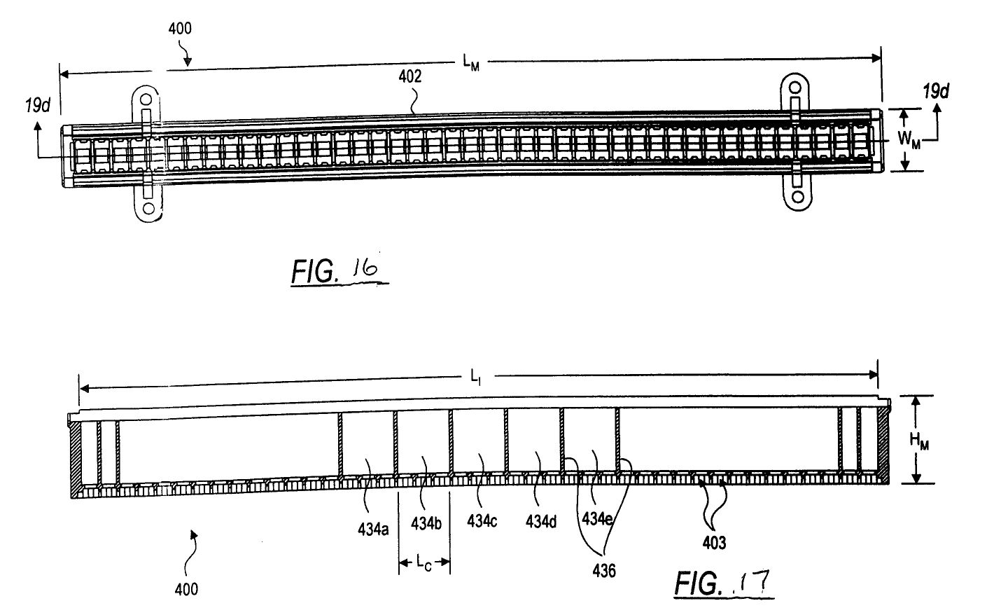

As best seen in FIGS. 16 and 17, in one embodiment, the scanhead 400 has a length L_{M} of 7.326 inches, a height H_{M} of 0.79 inches, and a width W_{M} of 0.5625 inches. Each cell has a length L_{C} of ½ inches and the scanhead has an overall interior length L_{I} 7.138 inches. In the embodiment illustrated, the scanhead 400 is populated with five full color cells 434a, 434b, 434c, 434d and 434e laterally positioned across the center of the length of the scanhead 400 and one edge sensor 438 at the left of the first color site 434a. The edge sensor 438 comprises a single sensor without a corresponding filter to detect the intensity of the reflected light and hence acts as a bill edge sensor.

While the embodiment shown is populated with five full color cells, because the body 402 of the scanhead 400 has sensor and filter receptacles 403 to accommodate up to forty-three filters and/or sensors, the scanhead 400 may be populated with a variety of color cell configurations located in a variety of positions along the length of the scanhead 400. For example, in one embodiment only one color cell 434 may be housed anywhere on the scanhead 400. In other situations up to fourteen color cells 434 may be housed along the length of the scanhead 400. Additionally, a number of edge sensors 438 may be located in a variety of locations along the length of the scanhead 400.

Moreover, if all of the receptacles 403 were populated, it would be possible to select which color cells to use or process to scan particular bills or other documents. This selection could be made by a processor based on the position of a bill as sensed by the position sensors. This selection could also be based on the type of currency being scanned, for example, country, denomination, series, and the like, based upon an initial determination by other sensor(s) or upon appropriate operator input.

According to one embodiment, the cell partitions 436 may be formed integrally with the body 402. Alternatively, the body 402 may be constructed without cell partitions, and configured such that cell partitions 436 may be accepted into the body 402 at any location between adjacent receptacles 403. Once inserted into the body 402, a cell partition 436 may become permanently attached to the body 402. Alternatively, cell partitions 436 may be removeably attachable to the body such as by being designed to snap into and out of the body 402. Embodiments that permit cell partitions 436 to be accepted at a number of locations provide for a very flexible color scanhead that can be readily adapted for different scanning needs such as for scanning currency bills from different countries.

In this manner, standard scanhead components can be manufactured and then assembled into various embodiments of scanheads adapted to scan bills from different countries or groups of countries based on the positioning of cell locations. Accordingly, a manufacturer can have one standard scanhead body 402 part and one standard cell partition 436 part. Then by appropriately inserting cell partitions into the body 402 and adding the appropriate filters and sensors, a scanhead dedicated to scanning a particular set of bills can be easily assembled.

Alternatively, a universal scanhead can be manufactured that is fully populated with cells across the entire length of the scanhead. For example, the scanhead 400 may comprise fourteen color cells and one edge cell. Then a single scanhead may be employed to scan many types of currency. The scanning can be controlled based on the type of currency being scanned. For example, if the operator informs the currency handling system, or the currency handling system determines, that Canadian bills are being processed, the outputs of sensors in cells 434a-434e can be processed. Alternatively, if the operator informs the currency handling system, or the currency handling system determines that Thai bills are being processed, the outputs of sensors in cells near the edges of the scanhead can be processed.

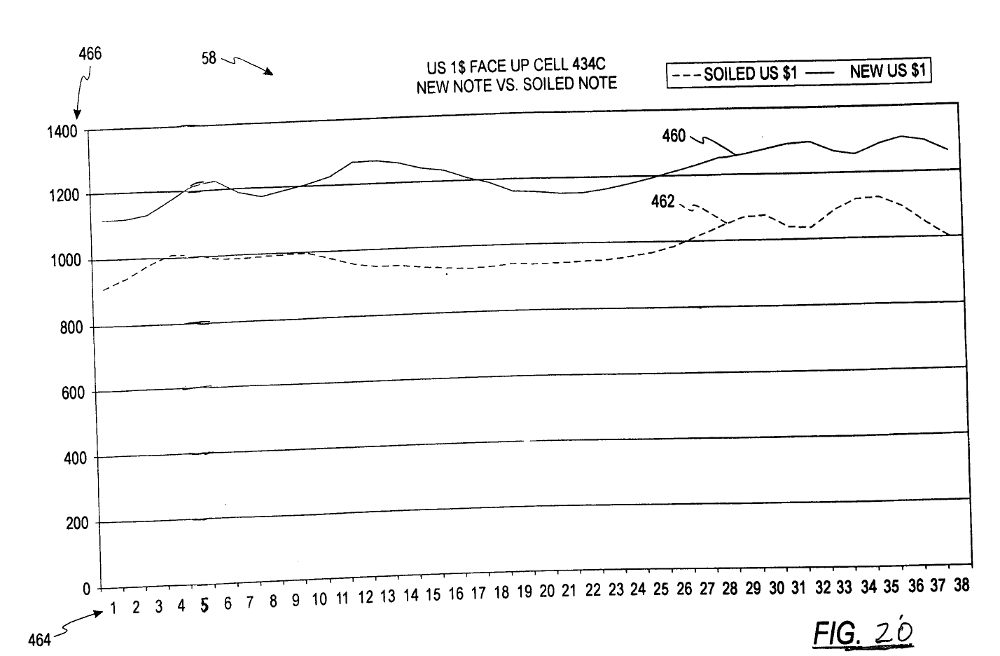

Reference is now made to FIG. 20 which shows a chart 458 depicting a comparison between a soil level for a new note (line 460) and soil level for a soiled note (line 462). The horizontal axis 464 shows the number of samples taken as the bill passed cell 434c. Chart 458 shows 38 samples were taken. The number of samples taken is a function of the width of the note (length along direction of travel) and speed of travel and other factors apparent to those of skill in the art. The vertical axis 466 shows a soil level value, for example the digital value of the analog value of the detected soil level. As stated above, any combination of red, blue, green or brightness (the sum of red, blue, green) can be used to determine soil level. The operator can set the thresholds for determining if a bill is unfit. Such thresholds may, for example, include amplitude, amplitude over a predetermined number of taken samples (38 taken samples in chart 458) or over a continuous span of samples.

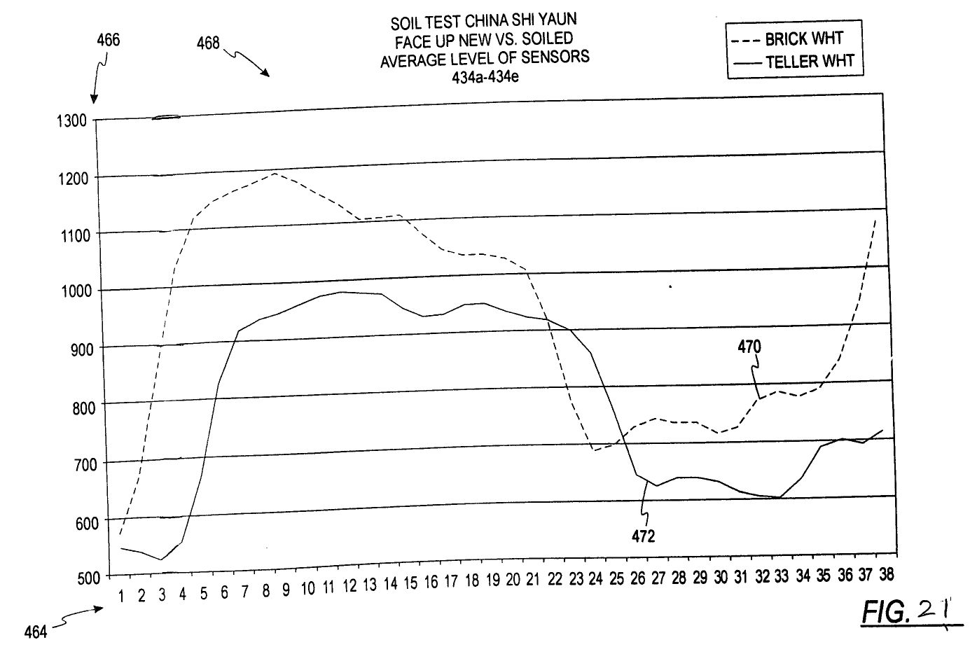

Reference is now made to FIG. 21 which shows a chart 468 depicting a comparison between soil levels of a new note (line 470) and a soiled note (line 472). Whereas the values depicted in chart 458 are based on a single cell, the values depicted in chart 468 represent the average of values detected by cells 434a-434e.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

What is claimed is:

1. A compact multiple pocket processing system comprising:
an input receptacle adapted to receive a stack of currency documents;
a plurality of output receptacles, each adapted to receive a stack of currency documents;
an evaluation unit positioned between the input receptacle and the plurality of output receptacles, wherein the evaluation unit is adapted to determine denomination of a currency document; and
a transportation mechanism adapted to transport currency documents from the input receptacle past the evaluation unit to the plurality of output receptacles, wherein the transportation mechanism comprises:
a facing section positioned upstream of the one or more output receptacles; and
a throughway section positioned upstream of the one or more output receptacles, wherein currency documents selectively faced; and
wherein the compact processing system as a volume less than about 25,000 inches³.

2. The system of claim 1, wherein a majority of the plurality of output receptacles are positioned below the transport mechanism.

3. The system of claim 1, further comprising a router positioned to route currency bills to one of either the facing section or the throughway section.

4. The system of claim 3, wherein the facing mechanism is positioned downstream of the router.

5. The system of claim 1, wherein the compact processing system includes a housing having a width less than an about 4.5 feet, a height less than about 2.25 feet and depth less than about 1.5 feet.

6. The system of claim 1, comprising at least one user interface positioned near the input receptacle.

7. A compact multi-pocket currency sorter, comprising:
a housing having a width, a depth and a height;
an input receptacle for receiving currency to be sorted;
at least five output receptacles contained within the housing and into which sorted currency is received; and
a currency processing mechanism contained within the housing, the currency processing mechanism receiving currency from the input receptacle, processing the currency, and sorting the currency into selected ones of the at least five output receptacles;
wherein the housing width is no more than about 54 inches, the housing depth is no more than about 17 inches and the housing height is no more than about 27 inches.

8. The sorter of claim 7 wherein the at least five output receptacles are positioned side-by-side across a bottom portion of the housing.

9. The sorter of claim 8 further including an additional off sort output receptacle, wherein the currency processing mechanism selectively sorts currency into the off sort output receptacle.

10. The sorter of claim 9 wherein the off sort output receptacle is separately positioned in the housing away from the at least five output receptacles.

11. The sorter of claim 7 wherein the at least five output receptacles do not include a storage cassette functionality.

12. The sorter of claim 7 wherein the currency processing mechanism includes a currency facing mechanism to selectively change face orientation of currency before being sorted into selected ones of the at least five output receptacles.

13. The sorter of claim 12 wherein the currency facing mechanism comprises:
a facing path that flips currency orientation;
a throughway path which does not flip currency orientation; and
a path selection device for choosing to route currency through the facing path or throughway path.

14. The sorter of claim 13 wherein the throughway path and the facing path have substantially identical path transit times.

15. The sorter of claim 13 wherein the throughway path and the facing path have substantially identical path lengths.

16. The sorter of claim 13 wherein the currency facing mechanism further includes a merging device to merge currency traveling in the facing path with currency traveling in the throughway path.

17. A compact multi-pocket currency sorter, comprising:
a housing containing a volume of not more than about 25,000 cubic inches;
an input receptacle for receiving currency to be sorted;
at least five output receptacles contained within the housing and into which sorted currency is received; and
a currency processing mechanism contained within the housing, the currency processing mechanism receiving currency from the input receptacle, processing the currency, and sorting the currency into selected ones of the at least five output receptacles.

18. The sorter of claim 17 wherein the at least five output receptacles are positioned side-by-side across a bottom portion of the housing.

19. The sorter of claim 18 further including an additional off sort output receptacle, wherein the currency processing mechanism selectively sorts currency into the off sort output receptacle.

20. The sorter of claim 19 wherein the off sort output receptacle is separately positioned in the housing away from the at least five output receptacles.

21. The sorter of claim 17 wherein the at least five output receptacles do not include a storage cassette functionality.

22. The sorter of claim 17 wherein the currency processing mechanism includes a currency facing mechanism to selectively change face orientation of currency before being sorted into selected ones of the at least five output receptacles.

23. The sorter of claim 22 wherein the currency facing mechanism comprises:
a facing path that flips currency orientation;
a throughway path which does not flip currency orientation; and
a path selection device for choosing to route currency through the facing path or throughway path.

24. The sorter of claim 23 wherein the throughway path and the facing path have substantially identical path transit times.

25. The sorter of claim 23 wherein the throughway path and the facing path have substantially identical path lengths.

26. The sorter of claim 23 wherein the currency facing mechanism further includes a merging device to merge currency traveling in the facing path with currency traveling in the throughway path.
